(19) United States
(12) Patent Application Publication
(10) Pub. No.: US 2013/0191522 A1
(43) Pub. Date: Jul. 25, 2013

(54) METHOD FOR MANAGING SMART OBJECTS USING DEREFERENCEABLE INFORMATION, AND SERVER THEREOF

(71) Applicant: Paul Barom JEON, Seoul (KR)

(72) Inventor: Paul Barom JEON, Seoul (KR)

(73) Assignee: SAMSUNG ELECTRONICS CO., LTD., Suwon-si (KR)

(21) Appl. No.: 13/489,057

(22) Filed: Jun. 5, 2012

(30) Foreign Application Priority Data
Jan. 19, 2012 (KR) 10-2012-0006378

(51) Int. Cl. G06F 15/173

(52) U.S. Cl. 709/223

(57) ABSTRACT

There is provided an apparatus and method to interact with a smart object s through a smart device. A smart object management method and apparatus includes creating information in which a smart object is described in a predetermined format including dereferenceable information. The information is registered. The method and apparatus receive an instruction to operate the smart object from a smart device to interact with the smart object. The method and apparatus search for information required for execution of the instruction with reference to the dereferenceable information, create a control instruction to execute the instruction based on found information, and transmit the control instruction to the smart object.

### CROSS-REFERENCE TO RELATED APPLICATION

This application claims the benefit under 35 U.S.C. §119(a) of a Korean Patent Application No. 10-2012-0006378, filed on Jan. 19, 2012, the entire disclosure of which is incorporated herein by reference for all purposes.

### BACKGROUND

1. Field

The following description relates to an apparatus and method for interacting with a smart object through a smart device.

2. Description of the Related Art

With “smartization” of electrical appliances, such as a TV, a refrigerator, a washing machine, a vacuum cleaner, an air-conditioner, etc., users are enjoying great convenience through the smart functions of these electrical appliances. To enjoy such convenience, users are required to be familiar with how to use the smart appliances in order to properly use and sufficiently enjoy the smart functions of the smart appliances. However, the smarter a smart appliance becomes, the more sophisticated a control mechanism for such smart appliance is necessary. The more sophisticated the control mechanism becomes, the user is required to invest time and effort to understand and become familiar on how to use the smart appliance.

Also, with an explosive increase of smart devices, such as a smart phone, a tablet PC, etc., the ability to remotely control and use smart appliances through smart devices are being introduced.

However, there may be limitation in properly using a smart appliance in an environment where various kinds of smart appliances coexist. If a user does not have sufficient knowledge on how to use the smart appliance, it would be pointless that the user is able remotely control the smart appliance through a smart device. For this reason, a method for allowing users to “smartly” use such smart appliances is needed.

### SUMMARY

The following description relates to a smart object management apparatus and method for enabling a smart device to easily control smart objects, and a management server thereof.

In accordance with an illustrative example, a smart object management method, includes creating information describing a smart object in a format comprising dereferenceable information, and receiving an instruction to operate the smart object from a smart device to interact with the smart object. The method is configured to search for information required to execute the instruction with reference to the dereferenceable information, create a control instruction to execute the instruction based on found information, and transmit the control instruction to the smart object.

The method also configures the format to comprise linked data to open, connect to, or share web data through the dereferenceable information. The linked data includes at least one of an address of the smart object, information on how to use the smart object, and information to be provided by the smart object. The dereferenceable information includes a Uniform Resource Indicator (URI). The method also configures the smart object to be a smart appliance to comprise a communication interface and configured to receive and execute receiving and executing the instruction.

The method includes configuring the smart device to comprise a mobile terminal including a processor and a communication interface and configuring the smart device to control the smart object. The receiving of the instruction includes receiving an instruction with semantic representation from the smart device.

In accordance with another illustrative example, a smart object management server includes a smart object data storage configured to store information describing a smart object, wherein the information includes a format comprising dereferenceable information. The server includes an instruction processor configured to receive an instruction to operate the smart object from a smart device to interact with the smart object. The server includes a smart object controller configured to search for information required to execute the instruction with reference to the dereferenceable information, to create a control instruction to execute the instruction based on found information, and to transmit the control instruction to the smart object.

The format is linked data to open, connect to, or share web data through the dereferenceable information. The linked data is at least one of an address of the smart object, information on how to use the smart object, and information to be provided by the smart object. The dereferenceable information includes a Uniform Resource Indicator (URI). The smart object is a smart appliance comprising a communication interface and configured to receive and execute the instruction. The smart device is a mobile terminal comprising a processor and a communication interface and configured to control the smart object. The instruction processor receives an instruction with semantic representation from the smart device.

According to an illustrative configuration, a computer program is embodied on a computer readable medium, the computer program being configured to control a processor to perform creating information describing a smart object in a format comprising dereferenceable information, and receiving an instruction to operate the smart object from a smart device to interact with the smart object. The computer program being configured to control a processor to perform searching for information required to execute the instruction with reference to the dereferenceable information, creating a control instruction to execute the instruction based on found information, and transmitting the control instruction to the smart object.

In accordance with an illustrative example, a object management method includes receiving an instruction with semantic representation from a smart device to control a smart object. The method includes searching for information required to execute the instruction with reference to dereferenceable information. The dereferenceable information includes a location of the information to execute the instruction. The method includes controlling the smart object to execute the instruction using a control instruction created based on the information from the search.

The method also configures the format to include linked data to open, connect to, or share web data through the dereferenceable information. The method includes configuring the linked data to comprise at least one of an address of the smart object, information on how to use the smart object, and information to be provided by the smart object.

According to an illustrative configuration, a computer program is embodied on a computer readable medium, the computer program being configured to control a processor to perform receiving an instruction with semantic representation from a smart device to control a smart object. The computer program being configured to control a processor to perform searching for information required to execute the instruction with reference to dereferenceable information, wherein the dereferenceable information includes a location of the information to execute the instruction. The computer program being configured to control a processor to perform controlling the smart object to execute the instruction using a control instruction created based on the information from the search.

In accordance with an illustrative example, a object management device, includes an instruction processor configured to receive an instruction with semantic representation from a smart device to control a smart object. The device includes a smart object controller configured to search for information required to execute the instruction with reference to dereferenceable information. The dereferenceable information includes a location of the information to execute the instruction, and to control the smart object to execute the instruction using a control instruction created based on the information from the search.

The format includes linked data to open, connect to, or share web data through the dereferenceable information. The linked data includes at least one of an address of the smart object, information on how to use the smart object, and information to be provided by the smart object.

Other features and aspects will be apparent from the following detailed description, the drawings, and the claims.

### BRIEF DESCRIPTION OF THE DRAWINGS

FIG. 1 illustrates an environment or system in which a smart object management method is executed, in accordance with an illustrative example.

FIG. 2 is a flowchart illustrating the smart object management method, in accordance with an illustrative example.

FIG. 3 is a diagram illustrating a smart object management server, in accordance with an illustrative example.

FIG. 4 illustrates a configuration of a smart object in which the smart object management method is executed, in accordance with an illustrative example.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

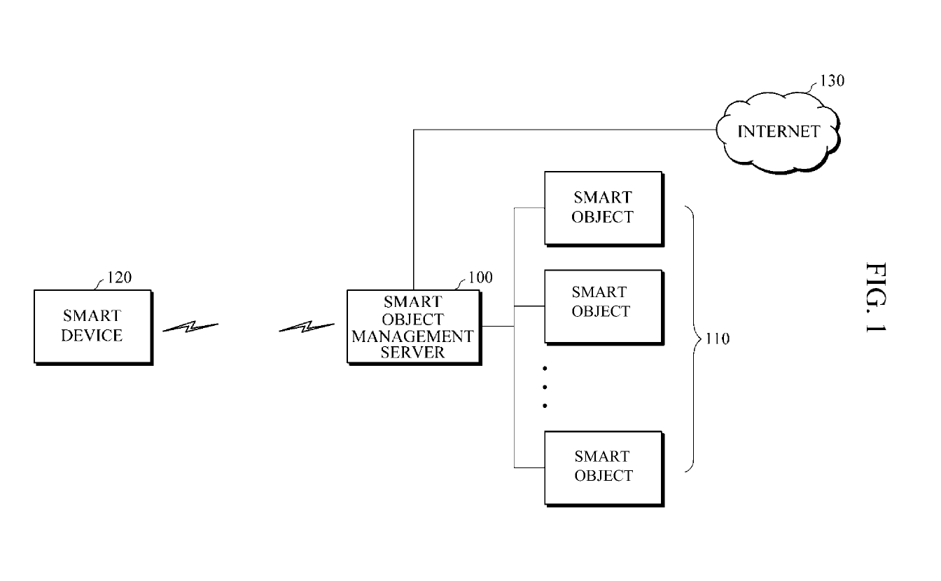

FIG. 1 illustrates an environment or system in which a smart object management method is executed, in accordance with an illustrative example.

Referring to FIG. 1, the environment where the smart object management method is executed includes a smart object management server 100, at least one smart object 110, and a smart device 120. The smart object 110 may be a smart appliance equipped with a communication interface and configured to receive and execute a user's instructions. The communication interface may be one of various wired/wireless communication interfaces, such as Ethernet, Wireless Fidelity (Wi-Fi), USB, etc. The smart appliance may be one of many kinds of smart appliances, such as a smart TV, a smart refrigerator, a smart washing machine, a smart air-conditioner, etc., which are used in daily life.

In one example, the smart device 120 is a mobile terminal equipped with a processor and a communication interface and configured to control the smart object 110. For example, the smart device 120 may be a smart phone, a table PC, etc. The smart object management server 100 and the smart object 110 may be operatively connected to each other through the Internet. The Internet 130 contains information about the smart object 110.

In the smart object control method executed in the system of FIG. 1, a user transmits an instruction to the smart object management server 100, through the smart device 120, to control the smart object 110. Upon receipt of the instruction from the user, without having to install a dedicated application for different smart objects, the smart device 120 creates an instruction with semantic representation and transmits the instruction to the smart object management server 100. To control smart objects using smart devices such as smart phone, tablet PC, dedicated applications for controlling the objects are generally installed in the smart devices. However, in an example configuration, because of the semantic representation to control command, it may not be necessary to require installing a dedicated application for different smart objects.

For example, if the smart object 110 is a smart TV, the smart device 120 transmits a schedule recording instruction to the smart object management server 100 to schedule-record a specific program in the smart TV, without having to install a dedicated application for remote control of the smart TV in the smart object management server 100. At this time, the start time, channel, etc. of the specific program may be provided as a semantic representation in the schedule recording instruction, without having to be individually set.

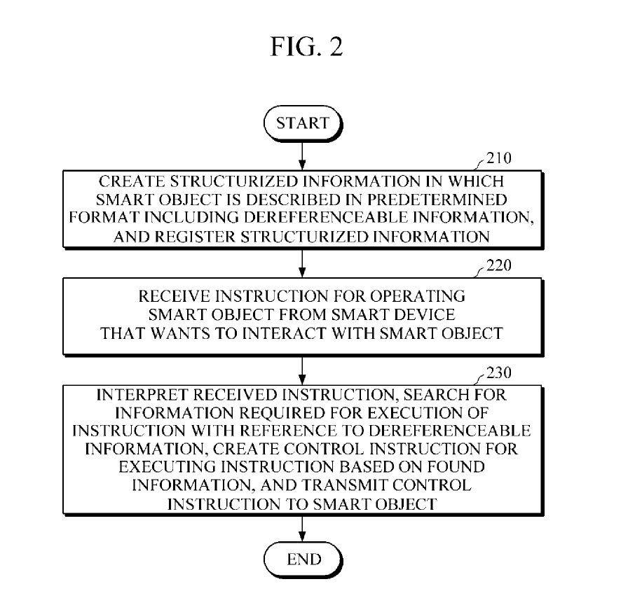

The smart object management server 100 receives the instruction from the smart device 120, interprets the instruction, searches for information required to execute the instruction from the Internet with reference to dereferenceable information corresponding to the interpreted instruction, and controls the smart object 110 according to the found information. Details about this operation will be described with reference to FIG. 2. Although the configuration of FIG. 1 illustrates the smart object management server 100 as receiving the instruction from the smart device 120, interprets the instruction, searches for information required to execute the instruction from the Internet with reference to dereferenceable information corresponding to the interpreted instruction, and controls the smart object 110 according to the found information, the smart device 120 may be structurally configured to perform the functions of the smart object management server 100.

FIG. 2 is a flowchart illustrating the smart object management method, in accordance with an illustrative example. The smart object management method may be performed by the smart device 120 or by the smart object management server 100. For purposes of brevity, the configuration of FIG. 2 will be described as performed at the smart object management server 100.

At 210, the method creates structurized information in which a smart object is described in a predetermined format including dereferenceable information. The method configures the smart object to receive web data with reference to the dereferenceable information, and the structurized information is registered.

The dereferenceable information, with reference to which desired information can be acquired, may include a location, for example, a Uniform Resource Indicator (URI), of the desired information on the web. A dereferenceable Uniform Resource Identifier or dereferenceable URI is a resource retrieval mechanism that uses any of the internet protocols (e.g. HTTP) to obtain a copy or representation of the resource it identifies.

The predetermined format may be linked data for opening, connecting to, and sharing web data that can be acquired through the dereferenceable information. The linked data may include the address of the smart object, how to use the smart object, information to be provided by the smart object, etc.

As described above, the smart object may be a smart appliance, such as a smart TV, a smart refrigerator, etc., equipped with a communication interface. The smart object is configured to execute an instruction received from a smart device. The smart device may be a mobile terminal, such as a smart phone, a tablet PC, etc., equipped with a processor and a communication interface and configured to control the smart object.

Furthermore, at 220, the method receives an instruction from a smart device wanting to interact with the smart object to operate the smart object. The instruction may be, as described above with reference to FIG. 1, an operation instruction with semantic representation from the smart device.

At 230, the method successively acquires information needed to execute the instruction with reference to dereferenceable information. The method also transmits a physical control instruction related to execution of the instruction to the smart object.

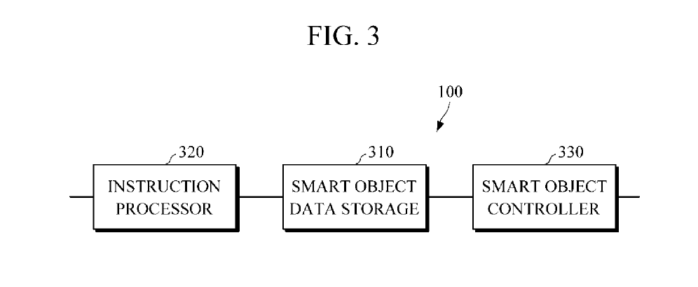

FIG. 3 is a diagram illustrating the smart object management server 100 illustrated in FIG. 1, in accordance with an illustrative example. The smart device 120 may be structurally configured to perform the functions of the smart object management server 100.

Referring to FIG. 3, the smart object management server 100 includes a smart object data storage 310, an instruction processor 320, and a smart object controller 330.

The smart object data storage 310 stores structurized information describing a smart object. The structurized information is created in a predetermined format including dereferenceable information. Other information may be included in the structurized information. For example, the structurized information may also be configured to include web data with reference to the dereferenceable information. The dereferenceable information, with reference to which desired information can be acquired, may include a location, for example, a Uniform Resource Indicator (URI), of the desired information on the web. Also, the predetermined format may be linked data for opening, connecting to, and sharing web data that can be acquired through the dereferenceable information. The linked data may include the address of the smart object, how to use the smart object, information to be provided by the smart object, etc.

The instruction processor 320 receives an instruction related to operation of a smart object from a smart device wanting to interact with the smart object. The instruction may be, as described above with reference to FIG. 1, an operation instruction with semantic representation, which is provided from the smart device. The instruction processor 320 processes the instruction and transfers a result of the processing to the smart object controller 330. Furthermore, the instruction processor 320 may also transfer the result of the processing to the smart device.

The smart object controller 330 searches for information necessary to execute the instruction with reference to the dereferenceable information, and transmits found information including, but not limited to, a physical control instruction to execute the instruction to the smart object. For example, the smart object controller 330 interprets the dereferenceable information (for example, linked data) to access the Internet, searches for a method of operating each smart object and a method of acquiring state data from the Internet, and controls the smart object based on the found information. Thereafter, the smart object controller 330 updates the linked data using the result of instruction execution transmitted to the smart object, or collects the state information of the smart object to update the linked data.

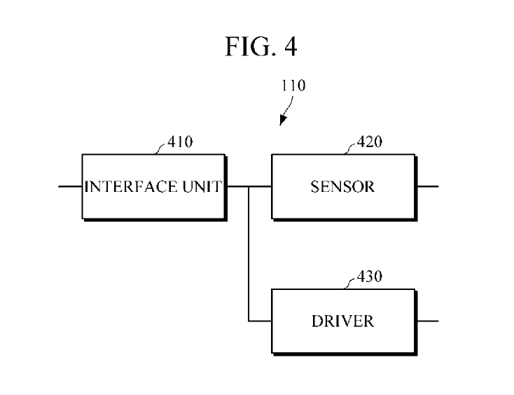

FIG. 4 illustrates a configuration of the smart object 110 (see FIG. 1) in which the smart object management method is executed, in accordance with an illustrative example.

Referring to FIG. 4, the smart object 110 includes an interface unit 410, a sensor 420, and a driver 430.

The interface unit 410 is configured to interact with the smart object management server 100 (see FIG. 1), to receive/transmit control instructions, messages, etc. from/to the smart object management server 100. The interface unit 410 is further configured to transmit linked data related to the smart object to the smart object management server 100 and register the linked data in the smart object management server 100. Also, the interface unit 410 collects sensed values detected by the sensor 420 and controls the driver 430 to control physical driving related to the operation of the smart object 110. For example, if the smart object 110 is a smart air-conditioner, the interface unit 410 may collect sensed values, such as a room temperature, a room humidity, etc., measured by the sensor 420. The interface unit 410 also operates the driver 430 according to the sensed values to turn on/off the smart air-conditioner.

The sensor 420 is a general sensor that can be installed in a smart object, and may be a temperature sensor, a humidity sensor, a motion sensor, or an Air Quality Sensor (AQS). The driver 430 performs various control operations for driving the smart object 110 according to the characteristics of the smart object 110.

Accordingly, a user can conveniently use the smart functions of each smart object through a smart device without sufficient knowledge about how to use the smart object, the state of the smart object, etc. in an environment where various smart objects coexist.

Moreover, because information of how to use individual smart objects, information related to the smart objects, etc. are stored in the form of linked data in an external server, a smart device can receive desired information from the external server as necessary. As a result, resource saving of smart objects or smart devices can be achieved.

Also, information about smart objects provided in the form of linked data is used to perform smart object core ontology extension.

In addition, user convenience can be improved by automatically connecting to each smart object through a smart device, without a user's direct intervention, to control or inquire of the smart object.

It is to be understood that in the embodiment of the present invention, the operations in FIG. 2 are performed in the sequence and manner as shown although the order of some steps and the like may be changed without departing from the spirit and scope of the present invention. In accordance with an illustrative example, a computer program embodied on a non-transitory computer-readable medium may also be provided, encoding instructions for performing at least the method described in FIG. 2.

Program instructions to perform a method described in FIG. 2, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion.

For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

The interface unit, the instruction processor, the smart object data storage, the smart object controller, the smart object management server, the sensor, and driver described herein may be implemented using hardware components and software components. For example, microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

As a non-exhaustive illustration only, the smart device and the smart object described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A smart object management method, comprising:
creating information related to a smart object in a format comprising dereferenceable information;
receiving an instruction to operate the smart object from a smart device to interact with the smart object;
searching for information required to execute the instruction based on the dereferenceable information,
creating a control instruction to execute the instruction based on found information; and
transmitting the control instruction to the smart object.

2. The smart object management method of claim 1, further comprising:
configuring the format to comprise linked data to open, connect to, or share web data through the dereferenceable information.

3. The smart object management method of claim 2, further comprising:
configuring the linked data to comprise at least one of an address of the smart object, information on how to use the smart object, and information to be provided by the smart object.

4. The smart object management method of claim 2, wherein the dereferenceable information comprises a Uniform Resource Indicator (URI).

5. The smart object management method of claim 1, further comprising:
configuring the smart object to be a smart appliance to comprise a communication interface and configured to receive and execute receiving and executing the instruction.

6. The smart object management method of claim 1, further comprising:
configuring the smart device to comprise a mobile terminal including a processor and a communication interface and configuring the smart device to control the smart object.

7. The smart object management method of claim 1, wherein the receiving of the instruction comprises receiving an instruction with semantic representation from the smart device.

8. A smart object management server comprising:
a smart object data storage configured to store information describing a smart object, wherein the information comprises a format comprising dereferenceable information;
an instruction processor configured to receive an instruction to operate the smart object from a smart device to interact with the smart object; and
a smart object controller configured to search for information required to execute the instruction with reference to the dereferenceable information, to create a control instruction to execute the instruction based on found information, and to transmit the control instruction to the smart object.

9. The smart object management server of claim 8, wherein the format is linked data to open, connect to, or share web data through the dereferenceable information.

10. The smart object management server of claim 9, wherein the linked data is at least one of an address of the smart object, information on how to use the smart object, and information to be provided by the smart object.

11. The smart object management server of claim 9, wherein the dereferenceable information comprises a Uniform Resource Indicator (URI).

12. The smart object management server of claim 8, wherein the smart object is a smart appliance comprising a communication interface and configured to receive and execute the instruction.

13. The smart object management server of claim 8, wherein the smart device is a mobile terminal comprising a processor and a communication interface and configured to control the smart object.

14. The smart object management server of claim 8, wherein the instruction processor receives an instruction with semantic representation from the smart device.

15. A computer program embodied on a non-transitory computer readable medium, the computer program being configured to control a processor to perform the method of claim 1.

16. A management method, comprising:
receiving an instruction with semantic representation from a smart device to control a smart object;
searching for information required to execute the instruction with reference to dereferenceable information, wherein the dereferenceable information comprises a location of the information to execute the instruction; and
controlling the smart object to execute the instruction using a control instruction created based on the information from the search.

17. The management method of claim 16, further comprising:
configuring the format to comprise linked data to open, connect to, or share web data through the dereferenceable information.

18. The management method of claim 17, further comprising:
configuring the linked data to comprise at least one of an address of the smart object, information on how to use the smart object, and information to be provided by the smart object.

19. A computer program embodied on a non-transitory computer readable medium, the computer program being configured to control a processor to perform the method of claim 16.

20. An object management device, comprising:
an instruction processor configured to receive an instruction with semantic representation from a smart device to control a smart object; and
a smart object controller configured to search for information required to execute the instruction with reference to dereferenceable information, wherein the dereferenceable information comprises a location of the information to execute the instruction, and to control the smart object to execute the instruction using a control instruction created based on the information from the search.

21. The object management device of claim 20, wherein the format comprises linked data to open, connect to, or share web data through the dereferenceable information.

22. The object management device of claim 21, wherein the linked data comprises at least one of an address of the smart object, information on how to use the smart object, and information to be provided by the smart object.
